(19) United States
(12) Patent Application Publication
(10) Pub. No.: US 2024/0028584 A1
(43) Pub. Date: Jan. 25, 2024

(54) DISTRIBUTED LEDGER SYSTEM AND METHOD

(71) Applicant: DENSO CORPORATION, Kariya-city (JP)

(72) Inventors: Yawen HUANG, Kariya-city (JP); Haolun HUANG, Kariya-city (JP); Xin XU, Kariya-city (JP)

(21) Appl. No.: 18/472,108

(22) Filed: Sep. 21, 2023

Related U.S. Application Data
(63) Continuation of application No. PCT/JP2022/013368, filed on Mar. 23, 2022.
(60) Provisional application No. 63/165,520, filed on Mar. 24, 2021.

(51) Int. Cl. G06F 16/23

(52) U.S. Cl. CPC G06F 16/2365

(57) ABSTRACT

A distributed ledger system comprises participating nodes and a verification node selection device. The verification node selection device is configured to calculate a score for at least processing speed or reliability of a transaction for each of the participating nodes, and determine the verification nodes. Each of the selected verification nodes verifies the transaction to build a consensus.

### CROSS REFERENCE TO RELATED APPLICATION

The present application is a continuation application of International Patent Application No. PCT/JP2022/013368 filed on Mar. 23, 2022, which designated the U.S. and claims the benefit of priority from U.S. Provisional Application No. 63/165,520 filed on Mar. 24, 2021. The entire disclosures of all of the above applications are incorporated herein by reference.

### TECHNICAL FIELD

The present disclosure relates to distributed ledger systems.

### BACKGROUND

A conceivable technique describes Quorum which is known as an example of such a distributed ledger system. Quorum constitutes a consortium-type blockchain system composed only of authorized nodes.

### SUMMARY

According to one example of the present disclosure describes a distributed ledger system comprising participating nodes and a verification node selection device. The verification node selection device is configured to calculate a score for at least processing speed or reliability of a transaction for each of the participating nodes, and determine the verification nodes. Each of the selected verification nodes verifies the transaction to build a consensus.

### BRIEF DESCRIPTION OF DRAWINGS

Objects, features and advantages of the present disclosure will become more apparent from the following detailed description made with reference to the accompanying drawings. In the drawings:

FIG. 1 is a diagram conceptually illustrating an overall distributed ledger system according to one embodiment of the present disclosure;

FIG. 2 is a block diagram illustrating an entity according to one embodiment of the disclosure;

FIG. 3 is a block diagram illustrating a verification node selection device and a server according to one embodiment of the disclosure;

FIG. 4 is a flowchart illustrating verification node selection processing according to an embodiment of the present disclosure;

FIG. 5 illustrates a node number evaluation table according to an embodiment of the present disclosure;

FIG. 6 illustrates a processor utilization rate evaluation table according to an embodiment of the present disclosure;

FIG. 7 illustrates a memory utilization rate evaluation table according to an embodiment of the present disclosure;

FIG. 8 illustrates a physical location evaluation table according to an embodiment of the present disclosure;

FIG. 9 illustrates an entity size evaluation table according to an embodiment of the present disclosure;

FIG. 10 illustrates an elapsed years evaluation table according to an embodiment of the present disclosure;

FIG. 11 is a diagram illustrating an example of node information and a result of verification node selection processing according to an embodiment of the present disclosure;

FIG. 12 is a flow chart illustrating a consensus building processing and a ledger update processing according to one embodiment of the present disclosure;

FIG. 13 illustrates a consensus building processing according to one embodiment of the present disclosure; and

FIG. 14 is a diagram conceptually illustrating an overall distributed ledger system according to modification of the present disclosure.

### DETAILED DESCRIPTION

A distributed ledger database represented by a blockchain system exists across multiple nodes through a P2P network, and each node replicates and stores the same ledger. For example, Quorum is known as an example of such a distributed ledger system. Quorum constitutes a consortium-type blockchain system composed only of authorized nodes. In Quorum, it may be possible to select Raft or IBFT (Istanbul Byzantine Fault Tolerance) in which a specific verification node verifies a transaction as a consensus building algorithm having Byzantine fault tolerant. However, since the verification node that achieves these consensus building algorithms is always the same, for example, even when the processor usage rate of the verification node is high and the resources available for the verification are low, the consensus building may be performed by that verification node. Therefore, it may take a long time to form a transaction consensus.

According to one aspect of the present disclosure, a distributed ledger system may comprise: a plurality of participating nodes each including a processor and a memory, each storing in the memory a ledger in which a transaction is recorded; and a verification node selection device that is configured to perform a verification node selection processing that selects a plurality of verification nodes for verifying a transaction from the plurality of participating nodes. The verification node selection device, as the verification node selection processing, is configured to calculate a score for at least processing speed or reliability of a transaction for each of the plurality of participating nodes, and determine the plurality of verification nodes by selecting a predetermined number or more of the participating nodes having high scores from the plurality of participating nodes. Each of the selected plurality of verification nodes verifies the transaction to build a consensus.

According to another aspect of the present disclosure, a method for building a consensus by verifying a transaction in a distributed ledger system may comprise: calculating a score regarding at least processing speed or reliability of a transaction for each of a plurality of participating nodes storing in a memory a ledger in which the transaction is recorded; determining the plurality of verification nodes by selecting a predetermined number or more of the participating nodes having high scores from the plurality of participating nodes; and verifying the transaction by each of the selected plurality of validation nodes.

Hereinafter, an embodiment of the present disclosure will be described with reference to the drawings.

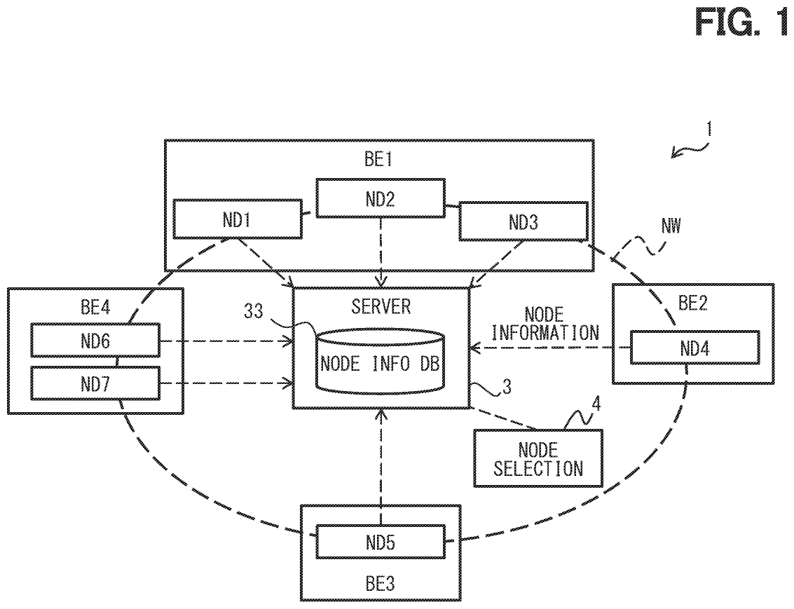

A distributed ledger system 1 (may be referred to as a system) of the present disclosure shown in FIG. 1 includes multiple nodes ND managed by respective business entities BE, a server 3 constructing the system 1, and a verification node selection device 4 (corresponding to a manager). Each business entity BE manages one or more nodes ND. A plurality of nodes ND managed by the same business entity BE are, for example, nodes ND managed by, for example, business establishments or affiliated companies of the business entity BE. The plurality of nodes ND are communicably connected to build a network NW. Incidentally, the system 1 may be configured using various distributed ledger technologies such as blockchain, Hashgraph, and Corda.

As shown in FIG. 1, the system 1 of the present embodiment is comprised of four business entities BE1 to BE4 and seven nodes ND1 to ND7. The business entity BE1 manages three nodes ND1 to ND3. That is, the nodes ND1 to ND3 belong to the business entity BE1. Also, the business entity BE2 manages one node ND4. That is, the node ND4 belongs to the business entity BE2. Also, the business entity BE3 manages one node ND5. That is, the node ND5 belongs to the business entity BE3. Further, the business entity BE4 manages two nodes ND6 and ND7. That is, the nodes ND6 and ND7 belong to the business entity BE4.

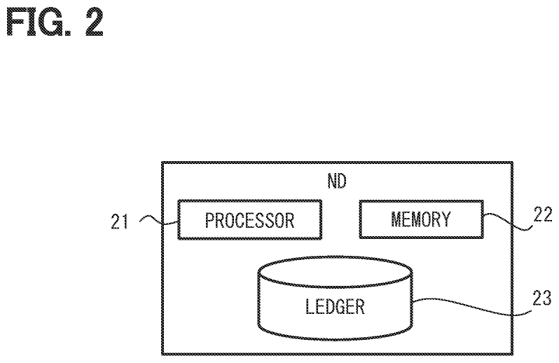

As shown in FIG. 2, each node ND has at least one processor (corresponding to a node processor 21) and at least one memory (corresponding to a node memory 22). The node memory 22 is at least one type of computer-readable non-transitory tangible storage medium, such as a semiconductor memory, a magnetic medium, an optical medium, for non-transitory storage of computer readable programs and data. For example, the node memory 22 may be provided by RAM or ROM. The node processor 21 includes, as a core, at least one type of, for example, a central processing unit (CPU), a graphics processing unit (GPU), a reduced instruction set computer (RISC)-CPU, and the like. The node processor 21 executes multiple instructions contained in a program stored in the node memory 22. The programs stored in the node memory 22 include programs for executing a consensus building processing, which will be described later.

Each node ND stores, for example, a ledger 23 that records transactions between a plurality of business entities BE participating in the system 1. The contents of the transaction include various transaction information according to the purpose of the system 1 and the business mode of the business entity BE participating. For example, when the system 1 constitutes a supply chain for automobile parts, transactions include transaction information such as purchase records of raw materials for automobile parts and shipping inventories at the time of shipment of automobile parts.

Also, each node ND is configured to receive a ledger update request from a user terminal. The user terminal is, for example, a smart phone, a tablet PC, a computer or the like, managed by each business entity BE, and operated by an employee of each business entity BE. For example, when shipping automobile parts, an employee of the business entity BE operates a user terminal to send a ledger update request to record a transaction such as a shipping inventory in the distributed ledger of the system 1. The ledger 23 is updated and synchronized by transmitting the ledger update request and adding the transaction authenticated through a consensus building processing to the ledger 23 stored in each node ND. Thereby, each node ND saves a common ledger 23.

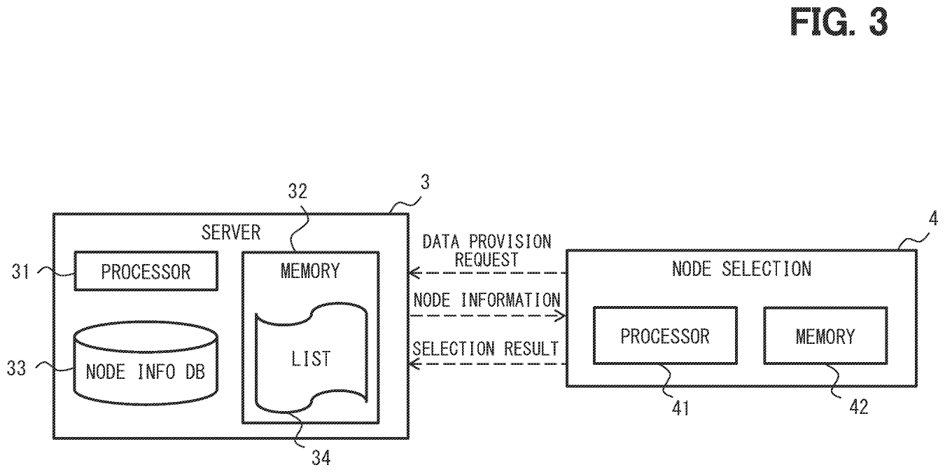

The server 3 shown in FIG. 3 is, for example, a cloud server including at least one processor (corresponding to a server processor 31) and at least one memory (corresponding to a server memory 32), as similar to the node ND. The server memory 32 is at least one type of computer-readable non-transitory tangible storage medium, such as a semiconductor memory, a magnetic medium, an optical medium, for non-transitory storage of computer readable programs and data. For example, the node memory 22 may be provided by RAM or ROM. The server processor 31 includes, as a core, at least one type of, for example, a central processing unit (CPU), a graphics processing unit (GPU), a reduced instruction set computer (RISC)-CPU, and the like.

The server processor 31 executes multiple instructions contained in programs stored in the server memory 32. The programs stored in the server memory 32 include a monitoring program for obtaining information on a node (a participation node) ND participating in the system 1.

As shown in FIG. 1, the server processor 31 periodically acquires information on all nodes ND participating in the system 1. The server processor 31 stores the acquired information on the nodes ND in the node information database 33. The information of the node ND acquired by the server processor 31 includes, for example, the business entity BE that manages each node ND (referred to as a corresponding business entity), the number of employees of the corresponding business entity, the number of years elapsed since each node ND joined the system 1 (referred to as an elapsed years) and the physical location of each node ND. These pieces of information are obtained at relatively long intervals (for example, every few days or months). As information on the nodes ND, the processor usage rate of each node ND, the memory usage rate of each node ND, and the like are acquired. These pieces of information are obtained at relatively short intervals (for example, every second or every minute). The server processor 31 updates the node information database 33 with the acquired node ND information.

The server memory 32 stores a verification node list 34 that specifies verification nodes verifying transactions. When a verification node is selected by the verification node selection device 4, the verification node list 34 is updated as needed based on the selection result. The server processor 31 causes the node ND specified in the verification node list 34 to function as a verification node.

The server 3 is managed by a third party with no interest in the participating business entities BE of the system 1, or jointly managed by all participating business entities BE. According to this configuration, it may be possible to prevent fraud such as falsification of the verification node list 34 by the participating business entity BE.

The verification node selection device 4 has at least one processor (corresponding to a selection device processor 41) and at least one memory (corresponding to a selection device memory 42), as similar to the node ND and server 3. The selection device memory 42 is at least one type of computer-readable non-transitory tangible storage medium, such as a semiconductor memory, a magnetic medium, an optical medium, for non-transitory storage of computer readable programs and data. For example, the node memory 22 may be provided by RAM or ROM. The selection device processor 41 includes, as a core, at least one type of, for example, a central processing unit (CPU), a graphics processing unit (GPU), a reduced instruction set computer (RISC)-CPU, and the like.

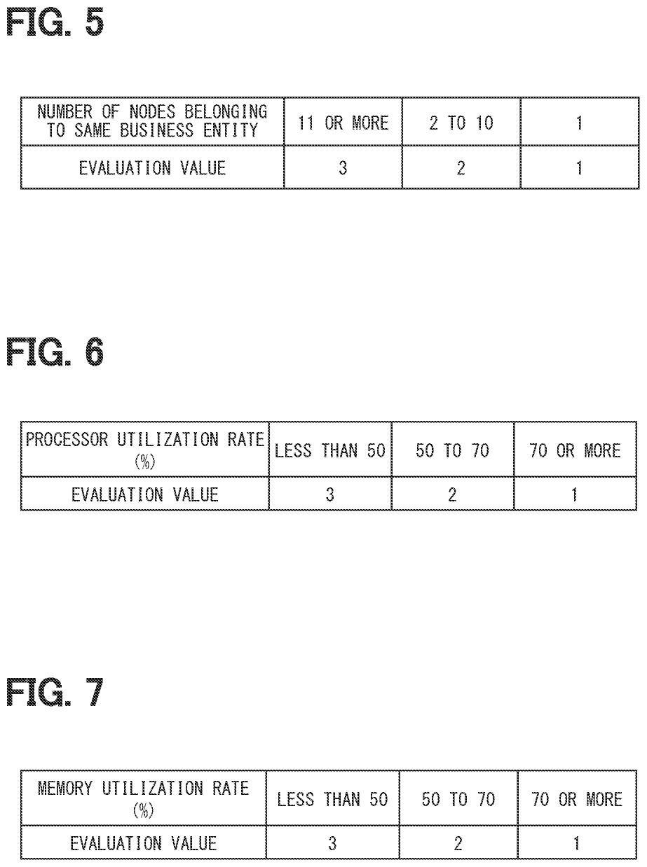

The selection device processor 41 executes a plurality of instructions contained in programs stored in the selection device memory 42. The programs stored in the selection device memory 42 include a verification node selection program for performing a verification node selection processing, which will be described later. Further, the selection device memory 42 stores a plurality of evaluation tables shown in FIG. 5 to FIG. 10. The contents of each evaluation table may be changed as needed, but such changes require the approval of all participating business entities BE.

As shown in FIG. 3, the verification node selection device 4 is communicably connected to the server 3 via the Internet, for example. The selection device processor 41 acquires node information stored in the node information database 33 of the server 3 by transmitting a data provision request to the server 3. Further, the verification node selection device 4 executes the verification node selection processing based on the acquired node information, and selects a verification node. By transmitting the result of the verification node selection processing to the server 3, the verification node list 34 of the server 3 is updated.

The verification node selection processing for selecting a verification node will be described below. The consensus building processing for updating the ledger 23 using the verified transaction will be described below.

(Verification Node Selection Processing)

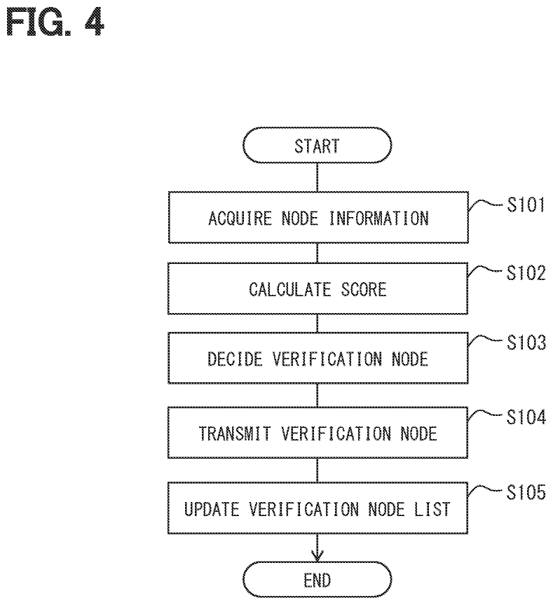

The verification node selection processing shown in FIG. 4 is executed by the verification node selection device 4 at a predetermined timing. The verification node selection processing is performed, for example, at the timing when the system 1 is constructed and started, or at the timing when a new node ND joins the system 1 or when a node ND leaves the system 1. In addition to these timings, the verification node selection processing is periodically executed at predetermined time intervals. The predetermined time is set, for example, according to the time interval (for example, every second or every minute) at which the server processor 31 updates the node information database 33. In the verification node selection processing, a verification node that performs a verification and consensus building of transaction in the consensus building processing is selected from a plurality of nodes ND.

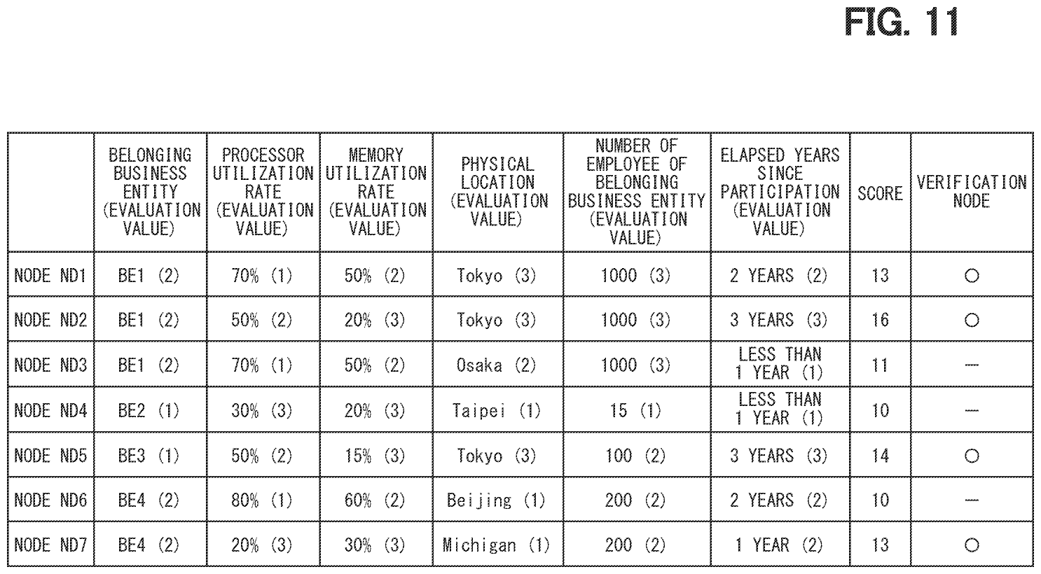

In S101, the selection device processor 41 obtains the node information (referring to FIG. 11) stored in the node information database 33 by requesting the server 3 to provide data. In S102, the selection device processor 41 calculates the score of each node ND based on the acquired node information and each evaluation table shown in FIG. 5 to FIG. 10. Note that the evaluation values in the evaluation tables shown in FIG. 5 to FIG. 10 are examples, and can be changed as appropriate. Here, the evaluation value is a value given according to the processing speed of consensus building and the reliability of the system 1. For each node ND, an evaluation value is calculated for a plurality of items (each node information item), and the total value of the evaluation values is obtained as a score. A node ND having a high score is preferentially selected as a verification node.

Here, an example of score calculation in S102 will be described with reference to FIG. 5 to FIG. 11. FIG. 11 is a table showing the node information of the nodes ND1 to ND7 comprising the system 1, showing the contents of the node information at a predetermined timing. As described above, the node information includes the business entity BE to which each node ND belongs, the processor usage rate and memory usage rate of each node ND at a predetermined timing, the physical location of each node, and the number of employees in the belonging business entity BE, and the number of years elapsed since the node ND joined.

FIG. 5 shows a node number evaluation table for calculating the node number evaluation value, that is, an evaluation value of the number of nodes. A business entity BE that manages a large number of nodes ND participating in the system 1 has little motivation to commit fraud such as falsification of transactions to damage the reliability and value of the system 1 itself. And the node ND belonging to such a business entity BE has also less merit of committing fraud. Therefore, in the present embodiment, in order to ensure that a node ND belonging to a business entity BE that manages a large number of nodes NDs is preferentially selected as a verification node, a high node number evaluation value is given to the node ND. Therefore, the node number evaluation value may be regarded as a reliability score for the reliability of the node ND in the system 1.

FIG. 6 and FIG. 7 respectively show a processor usage rate evaluation table and a memory usage rate evaluation table for calculating a processor usage rate evaluation value and a memory usage rate evaluation value. In general, the transaction processing speed of the node ND depends on the processor usage rate and the memory usage rate. In other words, a node ND with low processor usage rate and memory usage rate has many resources that can be allocated to transaction processing, and can process transactions faster than those with high usage. Therefore, in the present embodiment, a high processor utilization value and a high memory utilization evaluation value are given to a node ND with lower processor utilization and memory utilization so that node ND with lower processor utilization and memory utilization is preferentially selected as a verification node. The processor usage rate evaluation value and the memory usage rate evaluation value can be regarded as efficiency scores relating to the transaction processing speed in the node ND.

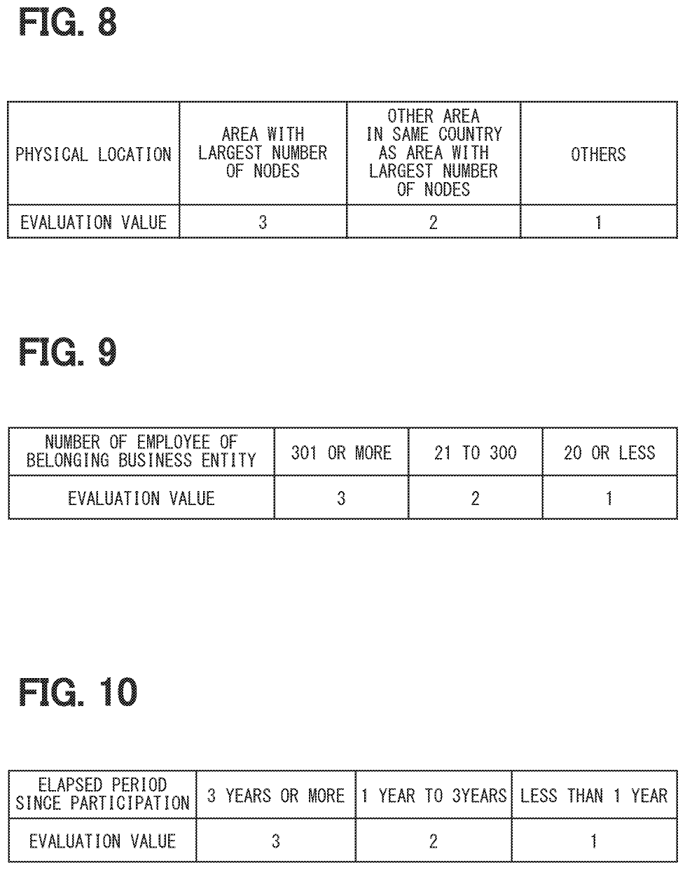

FIG. 8 shows a physical location evaluation table for calculating physical location evaluation values. The communication speed between nodes ND depends on the physical positional relationship between nodes ND. Specifically, when the physical positions of the nodes ND are close to each other, the communication speed between these nodes ND tends to be high, and latency may be low. Furthermore, in the transaction verification process, communication is performed between all verification nodes, the overall transaction processing speed can be increased by selecting as verification nodes NDs that are physically located close to each other gathered in the same region. Therefore, in the present embodiment, higher physical location evaluation values are given to groups of NDs located in regions where many NDs gather (referred to as an area with the largest number of nodes) so that nodes NDs with close physical locations to each other are preferentially selected as verification nodes. The nodes ND located in areas close to the area with the largest number of nodes also tend to have faster communication speeds with the group of node NDs in the area with the largest number of nodes. Therefore, in the present embodiment, the second highest physical location evaluation value is given to the node ND group located in other area within the same country as the area with the largest number of nodes. It should be noted that the physical location evaluation value can also be regarded an efficiency score for the transactions processing speed.

FIG. 9 shows a business entity scale evaluation table for calculating business entity scale evaluation values. In general, a business entity BE with a large scale is highly recognized and socially trusted in many cases. It is unlikely that such a business entity BE commit fraud such as falsification of transactions and take actions that would damage its own social standing. Also, a business entity BE with a large scale is considered to have sufficient capital to manage against software and hardware failures. In other words, the business entity BE with a large scale and the node ND belonging to the business entity BE are considered to have high reliability. Therefore, in the present embodiment, in order to ensure that a node ND belonging to a business entity BE with a large scale, specifically a node ND belonging to a business entity BE with a large number of employees, is preferentially selected as a verification node, the node ND is given a high entity size evaluation value.

FIG. 10 shows an elapsed years evaluation table for calculating the elapsed years evaluation value. In general, a node ND that has been participating in the system 1 for a long time is considered to have little motivation to commit fraud such as transaction falsification and damage the value of the system 1 itself. In other words, a node ND with a longer elapsed time since the node ND joined the system 1 is considered to be highly reliable. Therefore, in the present embodiment, in order to ensure that the node ND with the longer elapsed years since joining the system 1 is preferentially selected as the verification node, the node ND is given a high elapsed age evaluation value. The entity size evaluation value and the elapsed years evaluation value can be regarded as reliability scores regarding the reliability of the node ND, similar to the node number evaluation value.

An example of calculating the scores in S102 will be specifically described below using the node ND1 as an example. The node ND1 belongs to the business entity BE1, which has a total of three nodes ND. In this case, the node ND1 is given “2” as the node number evaluation value based on the node number evaluation table shown in FIG. 5. Also, the processor usage rate of the node ND1 shown in FIG. 11 is equal to 70% at this timing. In this case, the node ND1 is given “1” as the processor usage rate evaluation value based on the processor usage rate evaluation table shown in FIG. 6. The memory usage rate of the node ND1 shown in FIG. 11 is equal to 50%. In this case, the node ND1 is given “2” as the memory usage rate evaluation value based on the memory usage rate evaluation table shown in FIG. 7. As shown in FIG. 11, the node ND1 is located in Tokyo. In the example of FIG. 11, the number of nodes ND located in Tokyo is greater than the number of nodes ND located in other areas. In this case, the node ND1 is given “3” as the physical position evaluation value based on the physical position evaluation table shown in FIG. 8. As shown in FIG. 11, the business entity BE1 to which the node ND1 belongs has 1000 employees. In this case, the node ND1 is given “3” as the business entity size evaluation value based on the business entity size evaluation table shown in FIG. 9. As shown in FIG. 11, the number of years elapsed since the node ND1 joined the system 1 is two years. In this case, the node ND1 is given “2” as the elapsed years evaluation value based on the elapsed years evaluation table shown in FIG. 10. Further, the selection device processor 41 sums up each of the above evaluation values to calculate the score of the node ND1. The score of the node ND1 thus calculated is “13” (referring to FIG. 11). The selection device processor 41 similarly calculates scores for the other nodes ND2 to ND7.

In S103, the selection device processor 41 selects a predetermined number of nodes ND with high calculated scores (referred to as the number of verification nodes) as verification nodes. Here, when the number of fault-tolerant nodes in the system 1 is set to “f”, the number of verification nodes is set to “3f+1 or more”. In the present embodiment, it is assumed that f=1, and the number of verification nodes is set to four. Therefore, four or more nodes with the highest scores are selected by the selection device processor 41 as verification nodes. In other words, four or more nodes in order of increasing score are selected by the selection device processor 41 as verification nodes. In the present embodiment, as shown in FIG. 11, four nodes ND1, ND2, ND5, and ND7 out of seven nodes ND are selected as verification nodes. Also, in the system 1 of the present embodiment, the node ND2 with the highest score is set as the leader node in the consensus building processing.

In S104, the selection device processor 41 transmits to the server 3 the verification node selection result identifying the node ND selected as the verification node. The server 3 that has received the verification node selection result updates the verification node list 34 stored in the server memory 32 in S105.

According to the verification node selection processing described above, a verification node can be selected based on the processing speed of the node ND. Therefore, a node ND with a fast processing speed can be preferentially selected as a verification node. Therefore, it may be possible to perform efficient consensus building processing by a verification node with a high processing speed.

According to the verification node selection processing, a verification node can be selected based on the communication speed between the nodes ND. Therefore, it may be possible to preferentially select the node ND group with fast communication speed as verification nodes. Therefore, it may be possible to perform efficient consensus building processing by a verification node group with a fast communication speed.

According to the verification node selection processing, a verification node can be selected based on the reliability of the business entity BE to which the node ND belongs and the reliability of the node ND itself. Therefore, a highly reliable node ND can be preferentially selected as a verification node. Therefore, it may be possible to perform efficient consensus building processing by a verification node that is less likely to cause fraud or failure.

(Consensus Building Processing and Ledger Update Processing)

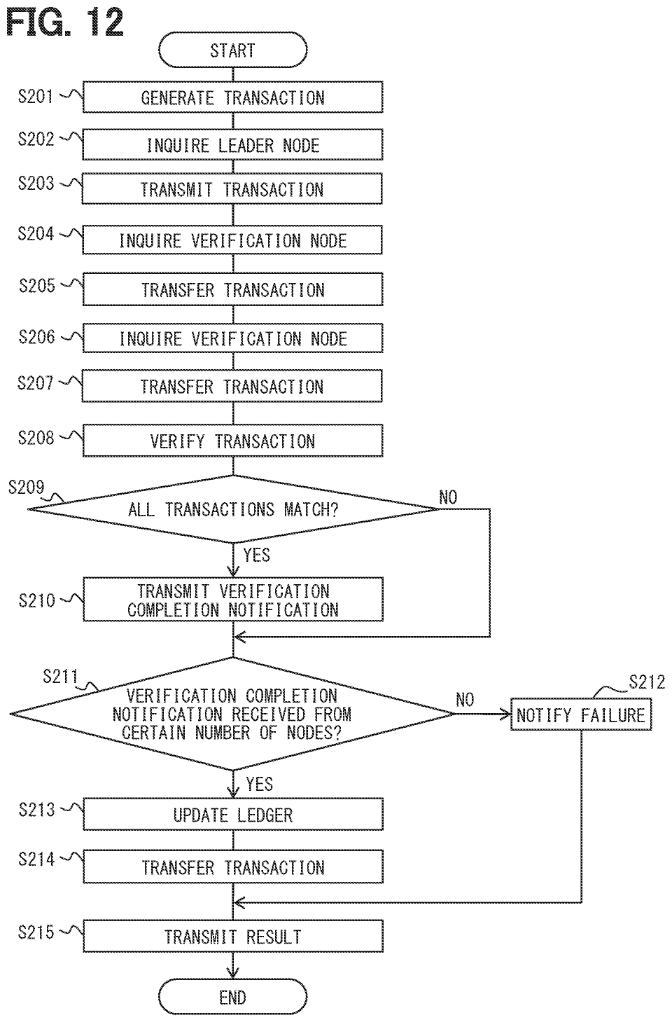

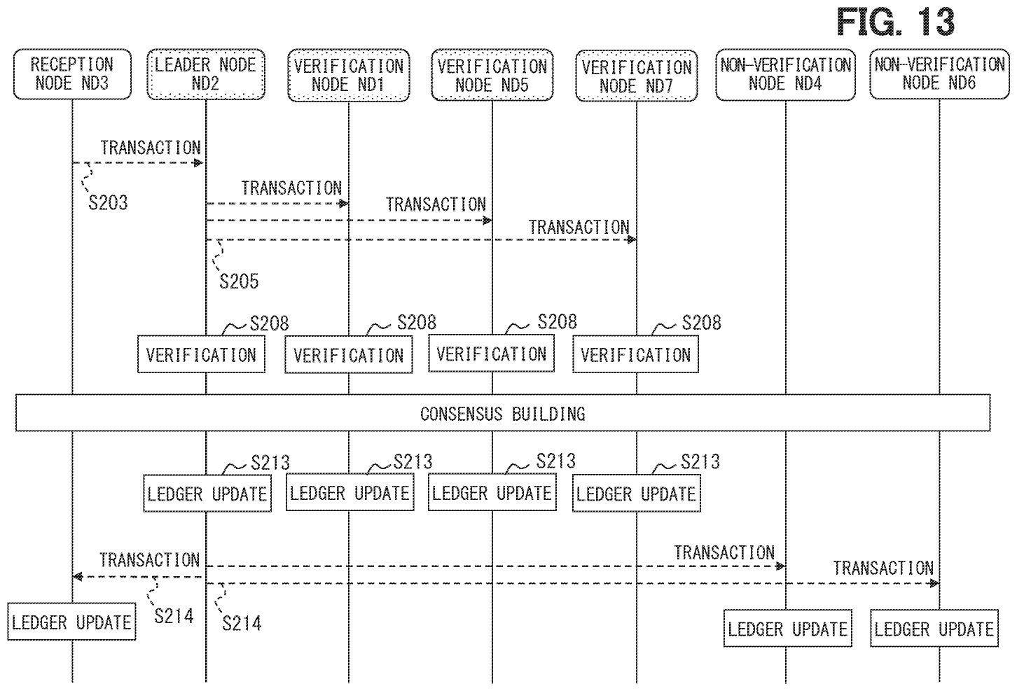

Next, the consensus building processing and the ledger update processing for updating the ledger 23 will be described with reference to FIG. 12 and FIG. 13. In FIG. 12 and FIGS. 13, S201 to S212 correspond to the consensus building processing, and S213 to S215 correspond to the ledger update processing. The consensus building processing of the present embodiment is executed in response to a ledger update request transmitted from a user terminal to any node ND. The consensus building processing is executed by the node ND that has received the ledger update request (referred to as a reception node), the leader node, and the verification node selected in the selection processing. Hereinafter, the consensus building processing and the ledger update processing in a case will be explained in which a node ND3 that has not been selected as a verification node (referred to as a non-verification node) receives a ledger update request.

In the following description, an example will be given of a case in which a business entity managing the node ND3 ships automobile parts. In this case, the node ND3 becomes a reception node that receives a ledger update request from a user terminal managed by the business entity. In S201, the reception node ND3 generates a transaction including the number of automobile parts to be shipped, a business entity of the shipping destination and the like based on the ledger update request.

Next, in S202, the reception node ND3 inquires of the server 3 which node ND is the leader node. When the server 3 receives the inquiry from the reception node ND3, the server 3 refers to the verification node list 34 stored in the server memory 32 and notifies the currently selected leader node (in the example of FIG. 11, corresponding to the node ND2 which is the highest scored node) to the reception node ND3.

In S203, upon receiving the notification from the server 3, the reception node ND3 transmits the generated transaction to the leader node ND2.

In S204, the leader node ND2 inquires of the server 3 which node ND is the verification node. The server 3, which has received the inquiry from the leader node ND2, refers to the verification node list 34 stored in the server memory 32 and informs the leader node ND2 of the currently selected verification nodes (nodes ND1, ND2, ND5, and ND7 in the example in FIG. 11).

In S205, upon receiving the notification from the server 3, the leader node ND2 transfers the transaction to the verification nodes ND1, ND5, and ND7 excluding itself among the verification nodes ND1, ND2, ND5, and ND7.

At S206, each of the verification nodes ND1, ND5, and ND7 inquires of the server 3 which node ND is the verification node. The server 3, which has received the inquiry from each of the verification nodes ND1, ND5 and ND7, refers to the verification node list 34 stored in the server memory 32 and informs each verification node ND1, ND5, ND7 of the currently selected verification node.

In S207, each of the verification nodes ND1, ND5, and ND7, upon receiving the notification from the server 3, transfers the transaction to the verification nodes other than themselves among the verification nodes ND1, ND2, ND5, and ND7.

In S208, each verification node ND1, ND2, ND5, ND7 including the leader node ND2 verifies the received transaction. In verifying transactions, at least it is confirmed whether or not all received transactions are consistent. In S209, each verification node ND1, ND5, and ND7 determines whether or not the transactions match as a result of the verification of transactions. When the transactions match, the consensus building processing proceeds to S210. By contrast, when the contents of the transaction are not correct, the consensus building processing proceeds to S211.

In S210, each verification node ND1, ND2, ND5, and ND7 transmits a notification (corresponding to a verification completion notification) to inform that the verification of the transaction is completed to all other verification nodes.

In S211, each of the verification nodes ND1, ND2, ND5, and ND7 determines whether or not the verification completion notifications have been received from a certain number or more of verification nodes. The verification node of the present embodiment determines whether or not the verification completion notifications have been received from ⅔ of the number of verification nodes (4)+1 or more, that is, from 3 or more verification nodes. As a result, the system 1 of the present embodiment has tolerance (referred to as Byzantine failure tolerance) to fraud or failure by any one of the verification nodes. When verification completion notifications have been received from a certain number or more of verification nodes, the consensus building is completed. The flow proceeds to S213 for the ledger update processing. By contrast, when the verification completion notifications have not been received from a certain number or more of verification nodes, the consensus building fails and the consensus building processing proceeds to S212.

In S212, the leader node ND2 transmits a notification to the reception node ND3 that the consensus building has failed.

In S213 of the ledger update processing following the consensus building processing, each verification node updates its own ledger 23 based on the agreed transaction. In S214, the leader node ND2 transfers (broadcasts) the transaction to the non-verification nodes ND3, ND4, and ND6 to update their ledgers 23.

In S215 following S212 or S214, the reception node ND3 transmits the results of the consensus building processing and the ledger update processing, that is, whether or not the ledger 23 has been updated, to the user terminal that requested the update of the ledger.

According to the consensus building processing and ledger update processing, the consensus building of the transaction to update the ledger 23 is performed by the verification node selected by the verification node selection processing. Also, in the verification node selection processing, a node ND having a high processing speed is preferentially selected as a verification node. Therefore, it may be possible to perform efficient consensus building by the node ND having a high processing speed.

In the verification node selection processing, a node ND group with fast communication speed is preferentially selected as verification nodes. Therefore, it may be possible to efficiently make consensus by the node ND group with high communication speed.

In the verification node selection processing, a high reliable node ND are preferentially selected as a verification node. Therefore, it may be possible efficiently form the consensus by a high reliable node ND.

Furthermore, the verification node selection processing described above is performed periodically. That is, verification nodes can change periodically. Therefore, it may be possible to always perform the consensus building processing by a suitable verification node.

Although one embodiment of the present disclosure has been described above, the present disclosure is not construed as being limited to the above-described embodiments, and can be applied to various embodiments and combinations within a scope that does not depart from the spirit of the present disclosure.

The consensus building processing of the present disclosure is not limited to the one described in the above embodiment, as long as the verification node selected in the verification node selection processing performs the verification and the consensus building of the transaction.

In the verification node selection processing, a score may be calculated based on a processor performance evaluation value that indicates the processing power (performance) of the processor. In this case, by assigning a high processor performance evaluation value to a node with high processing power, the node with high processing power is more likely to be selected as a verification node, so that the consensus building processing can be executed more efficiently.

The selection device processor 41 of the verification node selection device 4 may set (weight) a coefficient value for each evaluation value according to the purpose of the system 1 and the business mode of the participating business entity BE. The selection device processor 41 may calculate the sum of each weighted evaluation value as the score of each node ND. For example, it is assumed that a system 1 emphasizing the speed of consensus building is constructed. In this case, the selection device processor 41 may set “1” as a coefficient for the processor utilization rare evaluation value, the memory utilization rare evaluation value, and the physical location evaluation value, and set “0.5” as a coefficient for the other evaluation values. In this case, a node ND with a fast processing speed of the transaction and a group of node NDs with a fast communication speed are likely to be selected as verification nodes. Therefore, the consensus building speed in the system 1 can be improved compared to the case where no coefficient is set. Furthermore, for example, when building a system 1 that emphasizes safety, “1” may be set as the coefficient for the belonging business entity evaluation value, the business entity size evaluation value, and the elapsed years evaluation value, and “0.5” may be set as the coefficients for other evaluation values. In this case, a node ND with high reliability is likely to be selected as a verification node. Therefore, compared to the case where the coefficient is not set, it may be possible to reduce a possibility of fraud or failure occurring to improve the security of the system 1.

In the above embodiment, the node ND with the highest score is set as the leader node. The leader node may be a specific node ND. Also, the leader node may be changed in order at regular time intervals.

The verification node selection processing may be executed prior to the consensus building processing in response to a ledger update request from the user terminal.

The server 3 may distribute the verification node list 34 to each node ND in accordance with the update of the verification node list 34. In this case, in the consensus building processing, the reception node, the leader node, and each verification node may send transactions according to the distributed verification node list 34 without inquiring the server 3 about a leader node and verification nodes.

When the verification node selection processing and the consensus building processing cannot be executed due to a hardware or software failure of the server 3, all the participating nodes ND may verify the transaction as verification nodes to perform consensus building.

The server 3 may be made redundant by a backup server having the same configuration as the server 3 so that the verification node selection processing and the consensus building processing can be performed even when a hardware or software failure occurs in the server 3.

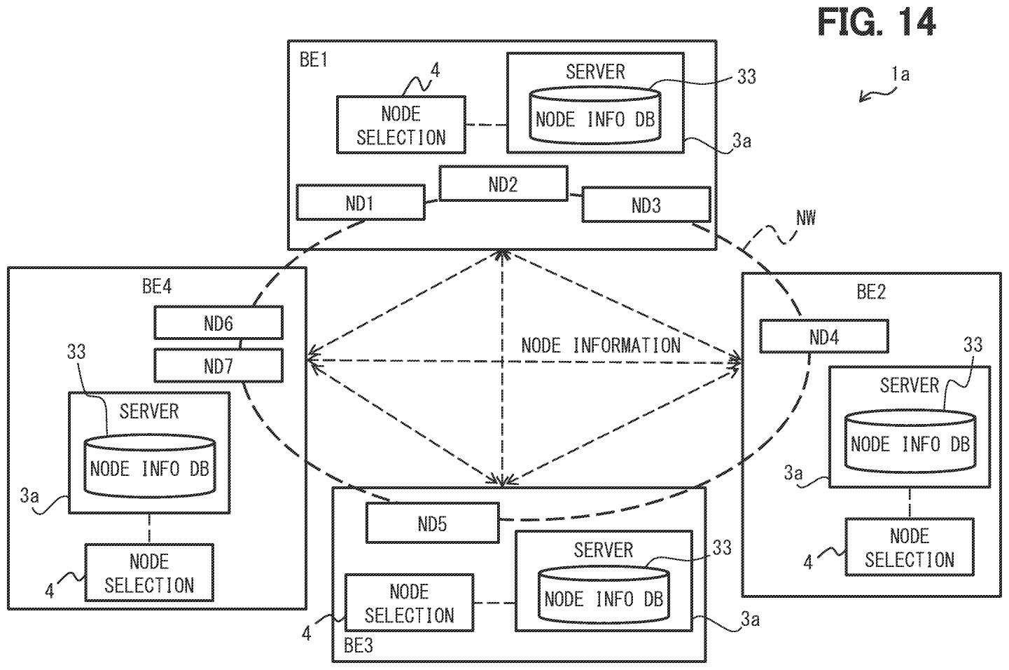

In the above-described embodiment, collection of node information and selection of verification nodes are performed by a single server and a single verification node selection device 4 managed by a third party. By contrast, in the system 1a according to the modified example shown in FIG. 14, each business entity BE may have a server 3a and a verification node selection device 4 respectively. In contrast to the server 3 of the above embodiment that obtains the node information of all participating nodes ND directly from each node ND, the server 3a directly obtains the node information of the node ND of the business entity BE to which the server 3a belongs from the node ND. Further, the server 3a acquires the node information of the node ND of the other business entity BE from the server 3a belonging to the other business entity BE. Thus, the node information of all the nodes ND is stored in the node information database 33 of a server memory in each server 3a. As described above, the node information databases 33 of each server 3a are synchronized with each other, and common node information is stored for all the nodes ND. The server memory of each server 3a stores a verification node list, as similar to the server 3 of the above embodiment. The verification node selection device 4 managed by each business entity BE is communicably connected to a server 3a (referred to as a corresponding server) managed by the same business entity BE. Further, the verification node selection device 4 can execute the verification node selection processing similar to the above embodiment by transmitting a data provision request to the corresponding server 3a, and can update the verification node list of the corresponding server 3a. In this modified example, one of the verification node selection devices 4 managed by each business entity BE executes the verification node selection processing. According to the system 1a of this modification, even if a hardware or software failure occurs in one of the verification node selection devices 4, it may be possible to continue the verification node selection processing by the other verification node selection device 4.

What is claimed is:

1. A distributed ledger system comprising:
a plurality of participating nodes each including a processor and a memory, each storing in the memory a ledger in which a transaction is recorded; and
a verification node selection device that is configured to perform a verification node selection processing that selects a plurality of verification nodes for verifying a transaction from the plurality of participating nodes,
wherein:
the verification node selection device, as the verification node selection processing, is configured to
calculate a score for at least processing speed or reliability of a transaction for each of the plurality of participating nodes, and
determine the plurality of verification nodes by selecting a predetermined number or more of the participating nodes having high scores from the plurality of participating nodes; and
each of the selected plurality of verification nodes verifies the transaction to build a consensus.

2. The distributed ledger system according to claim 1, wherein:
the verification node selection device calculates a score regarding the processing speed of the transaction as an efficiency score based on processor utilization rate of the each of the participating nodes.

3. The distributed ledger system according to claim 1, wherein:
the verification node selection device calculates a score regarding the processing speed of the transaction as an efficiency score based on memory utilization rate of the each of the participating nodes.

4. The distributed ledger system according to claim 1, wherein:
the verification node selection device calculates a score regarding the processing speed of the transaction as an efficiency score based on physical location of the each of the participating nodes.

5. The distributed ledger system according to claim 1, wherein:
the each of the participating nodes is managed by one of the plurality of business entities; and
the verification node selection device calculates a score regarding the reliability as a reliability score based on a total number of employees of the business entity that manages the each of the participating nodes.

6. The distributed ledger system according to claim 1, wherein:
the verification node selection device calculates a score regarding the reliability score as a reliability score based on an elapsed time since the each of the participating nodes has participated in the distributed ledger system.

7. The distributed ledger system according to claim 1, wherein:
the verification node selection device calculates the score for the each of the participating nodes by summing the efficiency score regarding the processing speed of the transaction and the reliability score regarding the reliability.

8. The distributed ledger system according to claim 1, wherein:
the verification node selection device calculates the score by summing a weighted value of the efficiency score and a weighted value of the reliability score.

9. The distributed ledger system according to claim 1, wherein:
the verification node selection device performs the verification node selection processing when a new node participates in the distributed ledger system as a participating node.

10. The distributed ledger system according to claim 1, wherein:
the verification node selection device periodically performs the verification node selection processing at a predetermined timing.

11. The distributed ledger system according to claim 1, wherein:
the verification node selection device performs the verification node selection processing when one of the plurality of participating nodes leaves the distributed ledger system.

12. A method for building a consensus by verifying a transaction in a distributed ledger system, comprising:
calculating a score regarding at least processing speed or reliability of a transaction for each of a plurality of participating nodes storing in a memory a ledger in which the transaction is recorded;
determining the plurality of verification nodes by selecting a predetermined number or more of the participating nodes having high scores from the plurality of participating nodes; and
verifying the transaction by each of the selected plurality of validation nodes.
